(19) United States
(12) Patent Application Publication
(10) Pub. No.: US 2006/0050355 A1
(43) Pub. Date: Mar. 9, 2006

(54) Wavelength locker comprising a diamond etalon

(75) Inventors: Herman Godfreid, Amsterdam (NL); Evert Houwman, Linden (NL); James Fraser, Devon (GB); Stephen Pope, Northampton (GB); Kevin Mullaney, Northampton (GB)

Correspondence Address: LAHIVE & COCKFIELD, LLP., 28 STATE STREET, BOSTON, MA, 02109, US

(73) Assignee: BOOKHAM TECHNOLOGY, PLC, TOWCESTER (GB)

(21) Appl. No.: 10/535,646

(22) PCT Filed: Nov. 18, 2003
(86) PCT No.: PCT/GB03/05000

§ 371 Date: May 20, 2005

(30) Foreign Application Priority Data
Nov. 21, 2002 (GB) 0227144.3

(51) Int. Cl. G02F 1/03

(52) U.S. Cl. 359/260

(57) ABSTRACT

A wavelength locker for locking the wavelength of a light beam substantially to a predetermined wavelength comprises at east one Fabry-Perot etalon arranged to receive a sample portion of the light beam and to produce at least one output light beam therefrom, the intensity of which is dependent upon the wavelength of the sample light beam, the Fabry-Perot etalon comprising diamond. Preferably the diamond etalon is a single crystal synthetic diamond having highly polished input and output faces without any reflective coatings.

The present invention relates to the locking of the wavelength of a light beam to a predetermined wavelength, or to one of a plurality of predetermined wavelengths. The invention has particular utility in the field of optical communications (and will be described primarily in relation thereto) but at least the broadest aspects of the invention are not limited to optical communications applications. The invention particularly relates to the use of Fabry-Perot etalons for wavelength locking.

In this specification, the terms “light” and “optical” will generally be used to refer not only to visible light but also to other wavelengths of electromagnetic radiation, for example in the wavelength range of about 200 nm to about 1 mm, i.e. from ultraviolet to the far infrared.

Wavelength lockers are well known and are used, for example, to ensure that an optical signal generated by a laser for transmission over an optical communications network has the correct wavelength. This is particularly important, for example, in wavelength division multiplex (WDM) optical communications systems, and even more important in dense wavelength division multiplex (DWDM) systems, in which a plurality of wavelength channels are used to transmit optical signals via a single optical fibre. If the wavelength of one or more of the optical signals does not fall within its correct pre-assigned wavelength channel, corruption of the signals and/or problems with detection of the signals may occur, for example.

There are currently two principal telecommunications bands, namely the C Band (191.6-196.2 THz) and the L Band (186.4-191.6 THz). Within these bands there are standard wavelength channels defined by the International Telecommunications Union (ITU) at spacings of 100 GHz (0.8 nm), 50 GHz (0.4 nm), or 25 GHz (0.2 nm). (In the future, additional bands, and narrower spacings of wavelength channels within the bands may be used.) There is therefore a need to “lock” optical signal wavelengths at these standardised wavelengths, for example, and wavelength lockers are used for this purpose.

International Patent Application WO 02/39553 (assigned to Bookham Technology PLC) discloses a wavelength locker for use with a wavelength tuneable laser, the wavelength locker in this case being based upon a Mach-Zehnder interferometer.

U.S. Pat. No. 5,798,859 discloses wavelength lockers based upon either one or two Fabry-Perot etalons. The wavelength lockers which use two Fabry-Perot etalons function by dividing the optical signal power from a tuneable laser equally between the two Fabry-Perot etalons, the etalons having similar, but slightly differing, wavelength dependent output responses. The output responses of the two etalons are chosen so that their amplitudes are identical at a predetermined input wavelength (for example 1550 nm). Consequently, if the input wavelength differs from this predetermined wavelength, the outputs of the two etalons will differ from each other. Electronic circuitry forming part of the wavelength locker compares the outputs of the two etalons and adjusts the wavelength of the output of the tuneable laser in dependence upon the ratio of the two etalon outputs so that it locks onto the predetermined (desired) wavelength (i.e. there is a feedback from the etalon outputs to the laser). This patent also discloses a wavelength locker which uses a single Fabry-Perot etalon in a similar manner to that of the two etalon locker. In the single etalon locker, the output of the etalon that has been transmitted through the etalon has a different wavelength dependency to the output of the etalon that has been reflected back from the etalon. The etalon is chosen so that the transmitted and reflected outputs have the same amplitude at a predetermined wavelength (e.g. 1550 nm), and the comparison, feedback and tuning of the laser so that it locks onto the predetermined wavelength occurs in the same way as in the two etalon wavelength locker.

According to a first aspect, the present invention provides a wavelength locker for locking the wavelength of a light beam substantially to a predetermined wavelength, the wavelength locker comprising at least one Fabry-Perot etalon arranged to receive a sample portion of the light beam and to produce at least one output light beam therefrom, the intensity of which is dependent upon the wavelength of the sample light beam, wherein the Fabry-Perot etalon comprises diamond.

A second aspect of the invention provides a wavelength drift detector for detecting the drift of the wavelength of a light beam from a predetermined wavelength, the wavelength drift detector comprising at least one Fabry-Perot etalon arranged to receive a sample portion of the light beam to produce at least one output light beam therefrom, the intensity of which is dependent upon the wavelength of the sample light beam, wherein the Fabry-Perot etalon comprises diamond.

Preferably the wavelength locker according to the first aspect of the invention, and/or the wavelength drift detector according to the second aspect of the invention, include(s) means, dependent upon the output of the etalon, for adjusting the wavelength of the light beam in order to reduce or eliminate its drift from the predetermined wavelength. Consequently, the second aspect of the invention preferably comprises a wavelength locker according to the first aspect of the invention.

The etalon preferably comprises an input face and an output face, which are opposite faces of the diamond (e.g. a diamond wafer). The etalon functionality therefore preferably occurs within the diamond material (rather than between exterior faces of two spaced apart diamond wafers, for example).

The light beam preferably comprises an optical signal, and the sample portion of the light beam preferably comprises a sample portion of the optical signal.

As discussed above, wavelength lockers which utilize one or more Fabry-Perot etalons are known, for example from U.S. Pat. No. 5,798,859. The wavelength locker according to the invention may be as described in that US patent, except that instead of the (or each) etalon being formed from spaced apart partially reflecting mirrors (with air or another gas filling the space between the mirrors, as disclosed in the patent) or some other conventional etalon, the etalon comprises diamond. Accordingly, the entire disclosure of U.S. Pat. No. 5,798,859 is incorporated herein by reference.

The use of diamond as an etalon material In a wavelength locker (or a wavelength drift detector) has several major advantages.

Firstly, diamond has a high refractive index. For example, it has a measured refractive index of approximately 2.39 at 1550 nm (compared to fused silica, for example, which has a refractive index of about 1.44 at the same wavelength). A benefit of this is that an etalon formed from diamond will generally be shorter in length (as measured along the optical path) for a given free spectral range, and hence more compact, than a conventional etalon that has a lower refractive index. (The free spectral range is a defined characteristic of an etalon, and is discussed below.) Consequently, by using a diamond, a Fabry-Perot etalon of a wavelength locker may be smaller than a conventional etalon, and this can be a highly significant benefit given the general need for miniaturisation and integration of optoelectronic systems.

Another benefit of the high refractive index of diamond is that the Fresnel reflectivity of the etalon is sufficiently high that the provision of reflective coatings may not be required, at least for some applications. Removing the need for reflective coatings is the second main advantage of using diamond as the etalon material, for several reasons. It reduces the number of manufacturing steps and consequently reduces manufacturing costs. Also, it avoids the potential problem of water absorption affecting the contrast ratio of the etalon over time (and consequently a diamond etalon will generally have a more stable contrast ratio over time than conventional coated etalons). Additionally, the avoidance of the need for reflective coatings prevents the possibility of damage to such coatings that could otherwise prevent the etalon from functioning properly.

The latter benefit is also related to a third main advantage of using diamond as the etalon material, namely that its high strength and hardness make it impervious to scratching (if uncoated).

A fourth major advantage of diamond as an etalon is that it has excellent thermal stability. For example, diamond has a low coefficient of thermal expansion and a low coefficient of refractive index change with temperature. The combination of these two properties results in an etalon with a highly stable free spectral range and an excellent wavelength stability (with temperature variation).

A fifth, and perhaps the greatest, advantage of diamond as an etalon material, is that diamond also has an exceptionally high thermal conductivity. This means that there will be a minimal temperature gradient within the etalon (i.e. the etalon will be generally isothermal throughout). A particular benefit of this property is that the temperature of the etalon, and especially the region of the etalon through which the light beam passes during use, may be accurately controlled. For example, due to the high thermal conductivity of diamond, by controlling the temperature of part of the exterior of the etalon (e.g. one external surface, such as a surface by which the etalon is mounted) the temperature of the internal region of the etalon through which the light beam passes is also thereby controlled, because the temperature of the internal region will be substantially the same as that of the exterior of the etalon.

A quantitative comparison of these properties of diamond as an etalon material (as measured for the purposes of the present invention) with fused silica is provided in the table below:

| | Units | Fused Silica | Diamond |
|---|---|---|---|
| Refractive index n (at 1550 nm) | | 1.444 | 2.3964 |
| dn/dT | ppm/K | 8.4 | 9.68 |
| Coefficient of thermal expansion | ppm/K | 0.55 | 0.8 |
| (CTE) | | | |
| Thermal conductivity (TC) | W/m/K | 1.38 | 2200 |
| Wavelength Stability | pm/K | 12.00 | 7.50 |
| Thickness (at a free spectral | mm | 2.08 | 1.25 |
| range of 50 GHZ and an incident | | | |
| light beam normal to the input | | | |
| face of the etalon) | | | |

Additionally, the large electromagnetic radiation transmission “window” of diamond (i.e. the large range of electromagnetic radiation wavelengths able to propagate through diamond) makes diamond suitable as an etalon for wavelengths from about 200 nm (UV) to about 1 mm (the far infrared).

The chemical inertness of diamond makes the etalon easy to clean, and it can therefore withstand generally any cleaning procedure other than those that involve a temperature above 500° C. in an oxidising atmosphere.

The use of the Fabry-Perot interferometer principle in a diamond wafer window of a CO₂ laser is known from U.S. Pat. No. 5,335,245. This patent describes the use of diamond wafers as the windows of a laser cavity. By correctly choosing the thickness of the transmitting wafer, certain spectral emission lines of the CO₂ laser can be suppressed in favour of another. However, this use of diamond as a laser cavity window is entirely different to the use of diamond as an etalon in a wavelength locker in accordance with the present invention. In the laser described in U.S. Pat. No. 5,335,245 the entire output of the laser is transmitted through the diamond wafer window, and the window merely blocks the transmission of wavelengths corresponding to certain spectral lines of the laser material in an entirely passive manner. In contrast, in the wavelength locker (or wavelength drift detector) according to the present invention the diamond etalon preferably is used in an active way as part of a feedback mechanism which actively detects wavelength drift in a light beam and uses the information actively to adjust the wavelength of the beam so that it locks onto the desired wavelength. Furthermore, this is achieved by only a sample portion of the light beam (for example less than 10%, e.g. between 2% and 4%, of the power) being received by the etalon.

As mentioned above, the wavelength locker and/or the wavelength drift detector according to the invention preferably include(s) means, dependent upon the output of the Fabry-Perot diamond etalon, for adjusting the wavelength of the light beam in order to reduce or eliminate its drift from the predetermined wavelength. Preferably such adjustment means comprises electronics arranged to control a light source that generates the light beam.

The wavelength locker or wavelength drift detector may be remote from the light source, in which case the adjustment means preferably transmits a control signal to the light source to adjust the wavelength of the light beam. Preferably, however, the wavelength locker or wavelength drift detector includes the light source of the light beam.

Also as mentioned earlier, the light beam preferably is an optical signal, for example a telecommunications optical signal.

A third aspect of the present invention provides an optical signal transmitter comprising a wavelength locker according to the first aspect of the invention or a wavelength drift detector according to the second aspect of the invention. Preferably the optical signal transmitter includes a light source which generates the optical signal.

The light source of the light beam preferably comprises a laser. The laser may be a tuneable laser (i.e. a laser whose output may be varied over a wide range of wavelengths, normally at least 70 nm). Alternatively, the laser may be a fixed wavelength laser (the output of which nonetheless may be adjusted over a small range of wavelengths to allow wavelength drift to be corrected).

A fourth aspect of the invention provides the use of diamond as a Fabry-Perot etalon in a wavelength locker according to the first aspect of the invention, or a wavelength drift detector according to the second aspect of the invention, or an optical signal transmitter according to the third aspect of the invention.

The diamond etalon preferably comprises a single crystal diamond.

Advantageously, the diamond may be a synthetic diamond. The diamond may, for example, be formed by chemical vapour deposition.

It is highly advantageous for the diamond etalon to be as free from defects (e.g. inclusions and/or striations) as possible.

A preferred diamond used as an etalon in the present invention can be produced using the method described in a UK patent application entitled “Optical Quality Diamond Material” filed by Element Six Limited simultaneously with the filing of the present application. This patent application describes the formation of a synthetic diamond by chemical vapour deposition of carbon onto a diamond substrate using a carbon source (preferably methane gas) using precisely controlled synthesis conditions.

Samples of the diamond used in the present invention were provided by Element Six BV under a confidentiality agreement for the purpose of the trial and the development of the invention (only).

The diamond etalon preferably comprises an input face and an opposite, output face, separated by the thickness d of the etalon. The input and output faces of the etalon preferably are substantially flat and preferably lie in substantially parallel planes. The input and output faces of the etalon are partially-reflective, and preferably are polished.

As is well known, the free spectral range (FSR) of the etalon is defined (in terms of frequency) as:
FSR=c/2nd

where: c is the speed of light
n is the refractive index of the etalon material (i.e. diamond)
d is the thickness of the etalon (i.e. the distance between the input and output faces)
   The free spectral range is the frequency (or wavelength) separation between adjacent maxima or minima in the frequency (or wavelength) dependent output characteristic of the etalon.

The thickness d of the diamond etalon preferably is at least 0.1 mm, more preferably at least 0.2 mm, especially at least 0.5 mm. The diamond etalon has a thickness d which preferably is no greater than 5.0 mm, more preferably no greater than 4.0 mm, especially no greater than 2.0 mm. The etalon has a thickness preferably In the range 1.0 mm to 1.5 mm. Preferably, the etalon has a thickness of 1.251 mm (for embodiments in which the incident light beam is normal to the input face of the etalon), thereby providing a free spectral range of 50 GHz at 1550 nm (since the refractive index of diamond at this wavelength has been measured, for the purposes of the present invention, to be 2.3964). (The advantage of a free spectral range of 50 GHz will be explained below.)

The modulation depth of the etalon characteristic is dependent upon the Fresnel reflectivity of the etalon faces. Each etalon face may be regarded as a boundary between two transmission media, namely the diamond material and the other medium immediately adjacent to the diamond material. For embodiments of the invention in which no coatings are applied to the diamond material, the transmission medium immediately adjacent to the diamond material will normally be air (but this need not necessarily be the case). The reflectivity (R) of each face of the etalon is given by the following equation:
R=((nₜ−nᵢ)/(nₜ+nᵢ)²

where: nᵢ is the refractive index of the incident medium
nₜ is the refractive index of the transmission medium
   For the input face of the etalon, the incident medium will be air (or some other medium immediately to the exterior of the input face of the diamond material) and the transmission medium will be the diamond material. For the output face of the etalon, the incident medium will be the diamond material and the transmission medium will be air (or some other medium immediately to the exterior of the output face of the diamond material).
   The modulation of the etalon characteristic can be defined by the ratio of the maximum transmission (peak) to the minimum (valley), known as the Contrast Ratio (CR).
   CR=Tmax/Tmin
   The Contrast Ratio can also be defined in terms of the etalon reflectivity:
   CR=((1+R)/(1−R))²
   The Insertion Loss (IL) of the etalon is determined by subtracting the maximum transmission (peak) of the characteristic from perfect transmission (100%).
   IL=1−Tmax

The invention will now be described, by way of example, with reference to the accompanying drawings, of which:

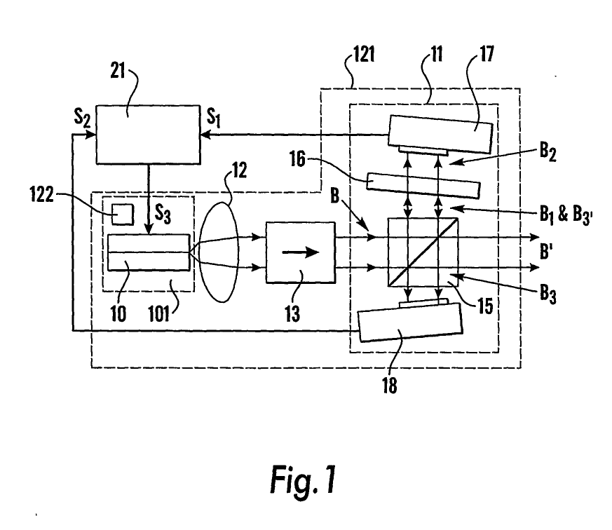

FIG. 1 is a schematic illustration of an embodiment of a wavelength locker or optical signal transmitter according to the invention;

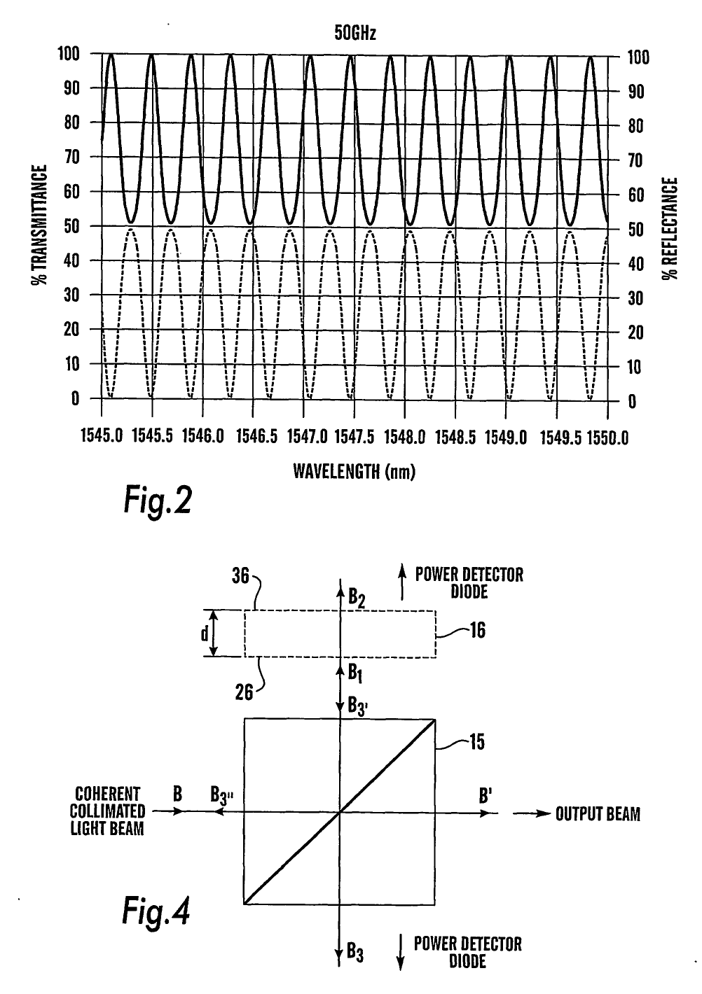

FIG. 2 is a graph illustrating the wavelength dependence of transmitted and reflected optical signals of a preferred diamond etalon according to the invention;

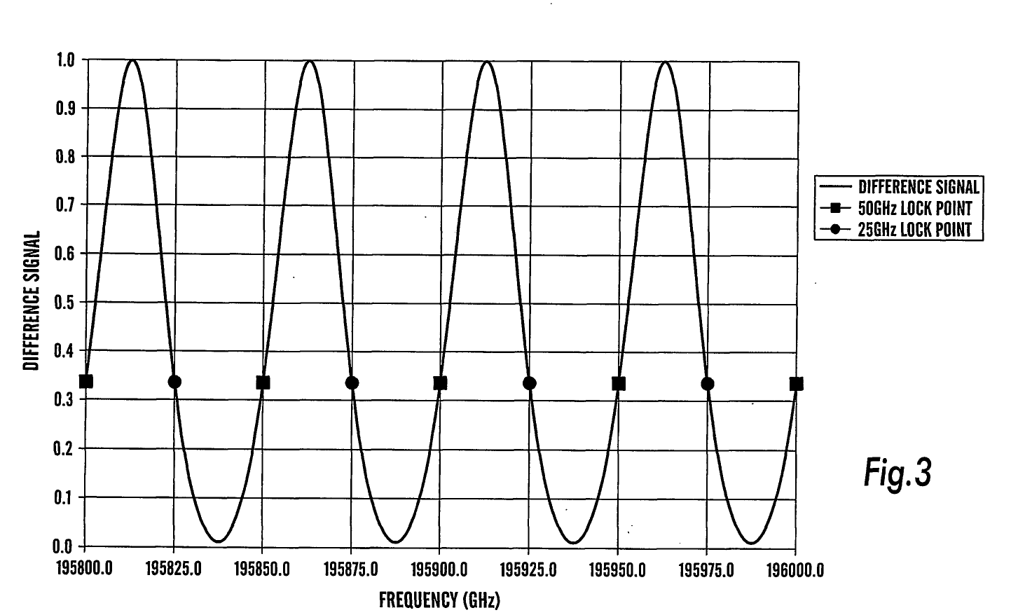

FIG. 3 is a graph illustrating a preset difference between the transmitted and reflected optical signals of FIG. 2 used to provide wavelength locking; and

FIG. 4 is a schematic illustration of the functioning of a beam splitter in an embodiment of a wavelength locker according to the invention.

FIG. 1 shows, schematically, an embodiment of a wavelength locker or optical signal transmitter according to the invention, comprising a laser device 10, being either a fixed wavelength laser such as a distributed feedback laser (DFB), or tuneable wavelength laser such as a distributed Bragg reflector (DBR), mounted with a thermistor 122 on a laser sub-assembly 101. Light from the laser device 10 is collimated by a collimating lens 12 and is transmitted through an optical isolator 13 as a parallel beam B. The beam B is then passed into a beam-splitter/etalon assembly 11 comprising an optical beam-splitter device 15, a Fabry-Perot etalon 16, and a pair of photodiodes 17 & 18. The Fabry-Perot etalon 16 comprises a single crystal synthetic diamond. The diamond etalon has an input face 26 and an output face 36 (see FIG. 4), separated by the thickness d of the etalon (which, together with the refractive index of the diamond, determines the free spectral range of the etalon). The input and output faces 26 and 36 are highly polished and do not contain any reflective coatings (or other coatings). The diamond preferably has a thickness d of 1.251 mm, in order to provide a free spectral range of 50 GHz.

The laser sub-assembly 101 and the other optical components in the wavelength locker, are all mounted on an optical assembly plate 121 having a high thermal conductivity. The optical output from the beam-splitter/etalon assembly 11 may be coupled through a second optical isolator, not shown, depending on the specific application of the wavelength beam splitter/etalon assembly.

Electrical signals S₁ and S₂ from the photodiodes 17, 18 are interfaced to control electronics 21, which are in turn interfaced to the laser diode to provide a closed loop feedback control of the laser operating wavelength. The laser diode device 10 preferably transmits light output to a DWDM optical telecommunications system. The thermister 122 is located adjacent the laser diode device 10 to maintain accurate control of the laser temperature since the laser has the highest sensitivity to wavelength variation caused by temperature change in the optical configuration.

The light from the laser diode device 10 is collimated by a lens 12 located close to the front facet of the laser, to provide a plane wavefront to the optical components in the beam splitter/etalon assembly (in particular to the etalon 16).

With reference to FIG. 4, the beam-splitter 15, notionally a cube, is a four port optical component consisting of light inlet, outlet and inlet/outlet ports. The beam-splitter device can, for example, be a plate type beam-splitter, or a cube type beam-splitter. The beam-splitter transmits, in part, the collimated beam emitted by the laser diode 10, onward to output optics or to further co-packaged electro-optic devices, for example, a modulator (and thence to an optical telecommunications network). The beam-splitter 15 diverts a small fraction B₁, typically 4%, of the collimated beam B power and hence typically 96% of the collimated beam power is available for the output B′. The 4% sample beam B₁, is substantially normal to the collimated beam B, and is directed towards the diamond etalon. The diamond etalon has wavelength dependent transmission and reflection characteristics, respectively B₂ (the transmitted output portion of the sample beam B₁) and B_{3′} (the reflected output portion of the sample beam B₁). The reflected portion B_{3′} from the diamond etalon traverses back across the beam-splitter, again substantially normal to the main collimated beam B. As the beam-splitter has typically 96% transmission, most of the reflected output of the etalon B_{3′} passes through the beam-splitter to emerge as a beam B₃, with a small fraction B_{3″} being reflected and lost in the optical isolator 13.

(An aspect of the optical design is that the beam-splitter permits substantially zero deviation of the main beam B/B′, and thus keeps the optical axis straight. This is especially important for co-packaged module applications to avoid an offset optical input into, for example, a downstream semiconductor electro-optic modulator.)

As already stated, the diamond etalon 16 has a transmitted output B₂ and a reflected output B_{3′} (which becomes B₃ after passing through the beam-splitter). The intensity of the transmitted output B₂ of the etalon is detected by photodiode 17, and the intensity of the reflected output B₃ of the etalon is detected by photodiode 18. These transmitted and reflected outputs of the etalon have wavelength dependent characteristics, and typical plots of these are shown in FIG. 2. The upper (darker) plot is that of the transmission output characteristic, and the lower (lighter) plot is that of the reflection output characteristic.

Wavelength locking is obtained from electronic processing of the difference between the etalon transmission and reflection output characteristics. As mentioned earlier, the free spectral range of an etalon is the frequency difference between adjacent maxima or minima in the output characteristics (this frequency difference is the same for both the transmission and the reflection characteristics). Consequently, locking to frequencies having a separation of X GHz is possible with an etalon having a free spectral range of 2X GHz, by using the difference between the transmission and reflection output characteristics.

The thickness of the diamond etalon preferably is selected such that both the transmission and the reflection output characteristics of the etalon have a free spectral range (FSR) of 50 GHz. The high refractive index of the diamond etalon gives a contrast ratio close to 2 so that the difference between the transmission and reflection characteristics is as shown in FIG. 3. To allow locking to the 25 GHz ITU grid frequencies, the amplitude of the difference characteristic is chosen such that the locking points are approximately, or exactly 25 GHz. Small variations in the absolute contrast ratio are accommodated in the control unit 21, during calibration.

Advantageously, the high refractive index of the diamond etalon avoids the need to use a much thicker etalon in order to achieve the 25 GHz wavelength lock points. Clearly, this ability to obtain both 50 GHz and 25 GHZ lock points using a smaller etalon helps reduce space requirements within the wavelength beam splitter/etalon assembly 11.

During fabrication of the beam splitter/etalon assembly 11, the diamond etalon 16 is actively angularly aligned within the beam splitter/etalon assembly 11 to achieve locking in the midpoint channel of the ITU grid, thereby minimising any free spectral range (FSR) walk-off at the extreme channels at the edge of, for example, the C-Band (191.6-196.2 THz).

Referring to FIG. 1, photodiodes 17 and 18 convert the transmitted and reflected light power from the diamond etalon into photo-currents to provide electrical signals S₁ and S₂ respectively. Preferably, these signals interface with the control electronics 21. Each photodiode converts the incident light into photo-current with a responsivity of typically 1 mA/mW i.e. to a first order, the photo-current is directly proportional to optical power. Each photodiode is mounted at typically 2°, to the light incident upon it to reduce optical reflections back into the optical system. Each photodiode is rotated in the opposite sense to the other, as shown, for example, in FIG. 1, so that optical phase differences in the detected signals from the diamond etalon are reduced. This is particularly advantageous in permitting the detected light powers to be used in determining main beam optical power i.e. to act as a power monitor. A suitable photodiode for this application is available from LGP Electro Optics, Woking, Surrey, UK, as part number GAP1060, for example.

The photodiode signals S₁ and S₂ provide inputs to the control electronics 21. These signals are then buffered and input to a difference amplifier which includes phase inversion of the input signals as appropriate. With the preferred embodiment the locked wavelength is achieved at nominally 66% amplitude of the etalon transmission characteristic, and 34% amplitude of the etalon reflection characteristic, by utilising the difference between reflected and transmitted light intensity for both the 25 GHz and 50 GHz cases.

With the laser device 10 operating nominally at an ITU wavelength, the difference between S₁ and S₂ is compared with a reference value stored in the control electronics 21. The control electronics then operates to adjust the laser wavelength, using a suitable control signal means, S₃, dependent on the wavelength control means of the laser device 10, such that the photodiode difference signal is equal to the stored reference value. Since the laser diode operating wavelength is sensitive to both temperature and drive current or field, closed loop control of the operating wavelength may be implemented by either changing the laser electrical operating conditions, or by changing the laser operating temperature. If the laser wavelength changes from the required value, the photodiode difference signal deviates away from the stored value and the control electronics 21 produces an error signal proportional to this deviation. By configuring the polarity of the error signal correctly, S₃ can be directed to steer the laser device 10 back to the correct ITU wavelength thus minimising the error and keeping the laser held at the required operating wavelength. This constitutes a feedback control loop. In the case where the laser device 10 is a tuneable laser the control electronics will need to adapt to each required laser device wavelength and drive the laser tuning means accordingly, as well as to adopt appropriate stored reference values for each ITU wavelength of operation. An exemplary storage means for both single wavelength and multiple wavelength operating wavelength data, is a look-up-table.

The stored value(s) in the control electronics 21 is determined during factory test of the product, such that the stored reference value is specific to both the exact wavelength being tested and locked, and the specific unit undergoing test, and constitutes a predetermined reference value. By testing each operating wavelength in turn and storing a corresponding reference value in the control electronics 21, each operating wavelength can be set to match the ITU grid to within a specified accuracy. Whilst the difference between S₁ and S₂ is the quantity compared with a stored reference value, those skilled in the art will appreciate that other data derived from S₁ and S₂ may be compared with an appropriate stored predetermined reference value or set of values.

The operation of phase inversion of the difference signal in the control electronics Is dependent on the wavelength being locked. Phase inversion is required between locked frequencies having a 25 GHz separation, since these lie on opposite sides of the 50 GHz etalon characteristic, see FIG. 3. Phase inversion may be applied at any appropriate point within the control electronics 21: for example, to the error signal produced from the photodiode difference signal and the reference signal amplitude stored in the control electronics.

It will be appreciated that the above described wavelength locker is merely one example of a wavelength locker in which the diamond etalon may be used. Wavelength lockers functioning in other ways, and/or using more than one diamond etalon (for example as described in U.S. Pat. No. 5,798,859) also fall within the scope of the present invention.

1. A wavelength locker for locking the wavelength of a light beam substantially to a predetermined wavelength, the wavelength locker comprising at least one Fabry-Perot etalon arranged to receive a sample portion of the light beam and to produce at least one output light beam therefrom, the intensity of which is dependent upon the wavelength of the sample light beam, wherein the Fabry-Perot etalon comprises diamond.

2. (canceled)

3. A wavelength locker according to claim 1, further comprising adjustment means, dependent upon the output of the etalon, for adjusting the wavelength of the light beam in order to reduce or eliminate a drift from the predetermined wavelength.

4. A wavelength locker or drift detector according to claim 3, wherein the adjustment means comprise control electronics.

5. A wavelength locker according to claim 3, wherein the adjustment means is arranged to control a light source that generates the light beam.

6. A wavelength locker according to claim 5, wherein the light source is remote from the wavelength locker, and the adjustment means transmits a control signal to the light source to adjust the wavelength of the light beam.

7. A wavelength locker according to claim 5, wherein the light source comprises a part of the wavelength locker or drift detector.

8. A wavelength locker according to claim 1, wherein the light beam comprises an optical signal, and the sample portion of the light beam comprises a sample portion of the optical signal.

9. (canceled)

10. A wavelength locker according to claim 5, wherein the light source comprises a laser.

11. (canceled)

12. A wavelength locker according to claim 1, wherein the diamond comprises a single crystal diamond.

13. A wavelength locker according to claim 1, wherein the diamond is a synthetic diamond.

14. A wavelength locker according to claim 13, wherein the diamond has been formed by chemical vapour deposition.

15. A wavelength locker according to claim 1, wherein the diamond is substantially free from defects.

16. A wavelength locker according to claim 1, wherein the diamond etalon comprises a partially-reflective input face and an opposite partially-reflective output face, separated by a thickness of the etalon.

17. A wavelength locker according to claim 16, wherein the input and output faces are substantially flat and lie in substantially parallel planes.

18. A wavelength locker according to claim 16, wherein the input and output faces are polished.

19. A wavelength locker according to claim 16, wherein the input face the output face is free from any coating.

20. A wavelength locker according to claim 16, wherein the thickness of the diamond etalon is at least 0.1 mm.

21. A wavelength locker according to claim 16, wherein the thickness of the diamond etalon is no greater than 5.0 mm.

22. A wavelength locker according to claim 20, in which the diamond etalon has a thickness in the range 1.0 mm to 1.5 mm.

23. A wavelength locker according to claim 1, wherein the diamond etalon has transmitted and reflected wavelength dependent output characteristics, each of which has a free spectral range of 2X GHz, allowing wavelength locking points at spacings of both 2X GHz and X GHz.

24. A wavelength locker according to claim 23, wherein wavelength locking points at spacings of X GHz are determined by a difference between the transmitted and reflected wavelength dependent output characteristics of the etalon.

25. A wavelength locker according to claim 24, wherein the amplitude of the difference between the transmitted and reflected wavelength dependent output characteristics of the etalon is preset such that the wavelength locking points are X GHz apart.

26. A wavelength locker according to claim 23, wherein X is 25.

27. A wavelength drift detector for detecting the drift of the wavelength of a light beam from a predetermined wavelength, the wavelength drift detector comprising at least one Fabry-Perot etalon arranged to receive a sample portion of the light beam to produce at least one output light beam therefrom, the intensity of which is dependent upon the wavelength of the sample light beam, wherein the Fabry-Perot etalon comprises diamond.

28. An optical signal transmitter comprising a wavelength locker according to claim 8, the optical signal transmitter including a light source which generates the optical signal.
